(19) United States
(12) Patent Application Publication
(10) Pub. No.: US 2012/0096349 A1
(43) Pub. Date: Apr. 19, 2012

(54) Scrubbing Touch Infotip

(75) Inventors: Qixing Zheng, Bellevue, WA (US); William David Carr, Redmond, WA (US); Xu Zhang, Redmond, WA (US); Ethan Ray, Redmond, WA (US); Gerrit Hendrik Hofmeester, Redmond, WA (US)

(73) Assignee: Microsoft Corporation, Redmond, WA (US)

(21) Appl. No.: 12/907,893

(22) Filed: Oct. 19, 2010

(51) Int. Cl. G06F 3/01

(52) U.S. Cl. 715/702

(57) ABSTRACT

An invention is disclosed for using touch input to display a representation of information for an item of a plurality of grouped items not otherwise accessible via other touch input. In an embodiment. In an embodiment, a user provides touch input to a touch-input device that comprises a scrubbing motion. Where the scrub corresponds to interacting with an item of a plurality of grouped items, a representation of information not otherwise accessible via other touch input is displayed (such as an infotip). In this manner, touch input may serve as a way to obtain a mouse-over event where there is no mouse pointer with which to create a mouse-over.

### BACKGROUND

Users may provide input to a computer system where they manipulate an on-screen cursor, such as with a computer mouse. In such a scenario, the user manipulates the computer mouse to cause corresponding movements of the on-screen cursor. This may be thought of as a “three state” system, where a mouse cursor may be (1) off of a user interface element (such as an icon, or text link); (2) on the UI element with a button of the mouse engaged; or (3) on the UI element without a button of the mouse engaged (this is sometimes referred to as “mousing over” or “hovering”). In response to a mouse-over, a system may provide a user with information about the icon or text that is being moused over. For instance, in some web browsers, a user may mouse-over a hypertext link, and the Uniform Resource Locator (URL) of that link may be displayed in a status area of the web browser. These mouse-over events provide a user with a representation of information that he may not otherwise be able to obtain.

There are also ways for users to provide input to a computer system that do not involve the presence of an on-screen cursor. Users may provide input to a computer system through touching a touch-sensitive surface, such as with his or her finger(s), or a stylus. This may be thought of as a “two-state” system, where a user may (1) touch part of a touch-input device; or (2) not touch part of a touch-input device. Where there is no cursor, there is not the third state of mousing over. An example of such a touch-sensitive surface is a track pad, like found in many laptop computers, in which a user moves his finger along a surface, and those finger movements are reflected as cursor or pointer movements on a display device. Another example of this touch-sensitive surface is a touch screen, like found in many mobile telephones, where a touch-sensitive surface is integrated into a display device, and in which a user moves his finger along the display device itself, and those finger movements are interpreted as input to the computer.

An example of such touch input is in an address book application that displays the letters of the alphabet, from A to Z, inclusive, in a list. A user may “scrub” (or drag along the touch surface) his or her finger along the list of letters to move through the address book. For instance, when he or she scrubs his or her finger to “M,” the beginning of the “M” entries in the address book may be displayed. The user also may manipulate the list of address book entries itself to scroll through the entries.

There are many problems with these known techniques for providing a user with information where the user uses touch input to the computer system, some of which are well known.

### SUMMARY

A problem that results from touch input lies in that there is no cursor. Since there is no cursor, there is nothing with which to mouse-over an icon or other part of a user interface, and thus mouse-over events cannot be used. A user may touch an icon or other user interface element to try to replace the mouse-over event, but this is both difficult for the user to distinguish from an attempt to click on the icon rather that “mouse-over” the icon. Even if the user has a mechanism for inputting “mouse-over” input as opposed to click input via touch, the icons or items (such as a list of hypertext links) may be tightly grouped together, and it may be difficult for the user to select a particular item from the plurality of grouped icons.

Another problem that results from touch input is that the input itself is somewhat imprecise. A cursor may be used to engage with a single pixel on a display. In contrast, people's fingers have a larger area than one pixel (and even a stylus, which typically presents a smaller area to a touch input device than a finger, still has an area larger than a pixel). That impreciseness associated with touch input makes it challenging for a user to target or otherwise engage small user interface elements.

A problem with the known techniques for using scrubbing input to receive information is that they are limited in the information that they present. For instance, in the address book example used above, scrubbing is but one of several ways to move to a particular entry in the address book. Additionally, these known techniques that utilize scrubbing fail to replicate a mouse-over input.

It would therefore be an improvement to provide an invention for providing a representation of information for an item of a plurality of grouped items via touch input. In an embodiment of the present invention, a computer system displays a user interface that comprises a plurality of grouped icons. The computer system accepts touch input from a user indicative of scrubbing. In response to this scrubbing user touch input, the system determines an item of the plurality of grouped items that the user input corresponds to, and in response, displays a representation of information for the item.

Other embodiments of an invention for providing a representation of information for an item of a plurality of grouped items via touch input exist, and some examples of such are described with respect to the detailed description of the drawings.

### BRIEF DESCRIPTION OF THE DRAWINGS

The systems, methods, and computer-readable media for providing a representation of information for an item of a plurality of grouped items via touch input are further described with reference to the accompanying drawings in which:

FIG. 1 depicts an example general purpose computing environment in which an aspect of an embodiment of the invention can be implemented.

FIG. 2 depicts an example computer including a touch-sensitive surface in which an aspect of an embodiment of the invention can be implemented.

FIG. 3 depicts an example grouped plurality of items for which an aspect of an embodiment of the invention may be implemented.

FIG. 4 depicts the grouped plurality of items of FIG. 3 for which a representation of information not otherwise available via user input is displayed in response to user touch input.

FIG. 5 depicts the grouped plurality of items of FIG. 4 for which a second representation of information not otherwise available via user input is displayed in response to additional user touch input.

FIG. 6 depicts an example word processor window in which an aspect of an embodiment of the invention may be implemented.

FIG. 7 depicts an example web browser window in which an aspect of an embodiment of the invention may be implemented.

FIG. 8 depicts an example text menu list in which an aspect of an embodiment of the invention may be implemented.

FIG. 9 depicts example operation procedures that implement an embodiment of the invention.

### DETAILED DESCRIPTION OF ILLUSTRATIVE EMBODIMENTS

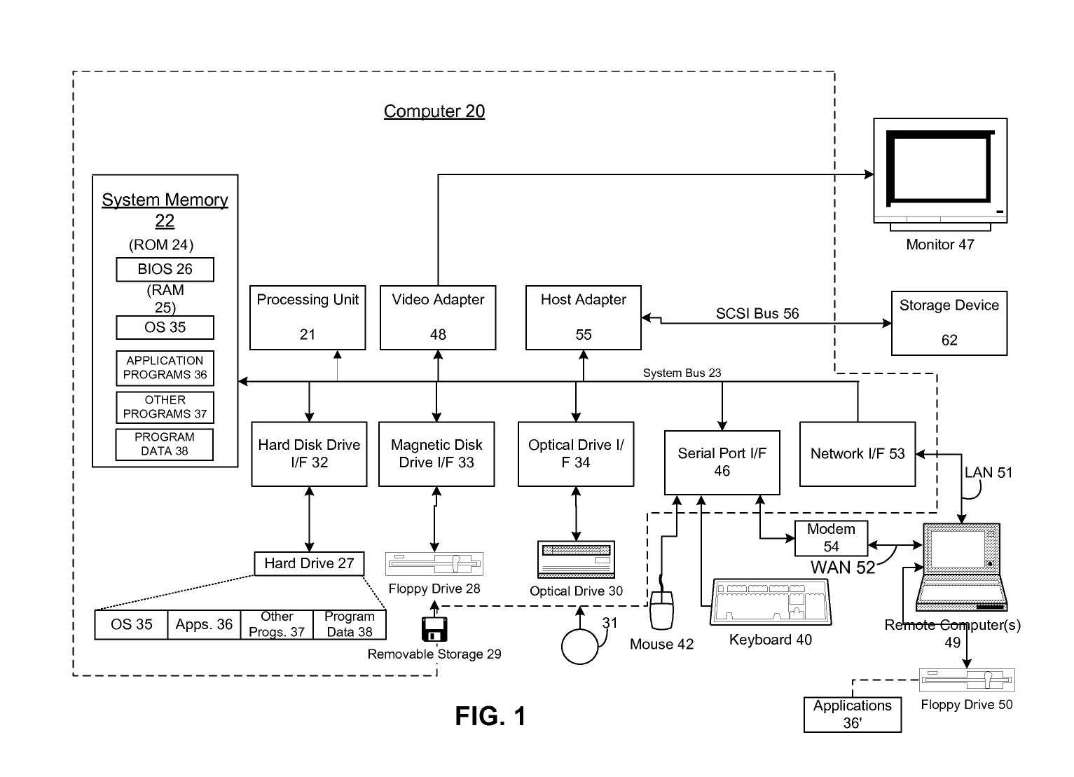

Embodiments may execute on one or more computer systems. FIG. 1 and the following discussion are intended to provide a brief general description of a suitable computing environment in which the disclosed subject matter may be implemented.

The term processor used throughout the description can include hardware components such as hardware interrupt controllers, network adaptors, graphics processors, hardware based video/audio codecs, and the firmware used to operate such hardware. The term processor can also include microprocessors, application specific integrated circuits, and/or one or more logical processors, e.g., one or more cores of a multi-core general processing unit configured by instructions read from firmware and/or software. Logical processor(s) can be configured by instructions embodying logic operable to perform function(s) that are loaded from memory, e.g., RAM, ROM, firmware, and/or mass storage.

Referring now to FIG. 1, an exemplary general purpose computing system is depicted. The general purpose computing system can include a conventional computer 20 or the like, including at least one processor or processing unit 21, a system memory 22, and a system bus 23 that communicative couples various system components including the system memory to the processing unit 21 when the system is in an operational state. The system bus 23 may be any of several types of bus structures including a memory bus or memory controller, a peripheral bus, and a local bus using any of a variety of bus architectures. The system memory can include read only memory (ROM) 24 and random access memory (RAM) 25. A basic input/output system 26 (BIOS), containing the basic routines that help to transfer information between elements within the computer 20, such as during start up, is stored in ROM 24. The computer 20 may further include a hard disk drive 27 for reading from and writing to a hard disk (not shown), a magnetic disk drive 28 for reading from or writing to a removable magnetic disk 29, and an optical disk drive 30 for reading from or writing to a removable optical disk 31 such as a CD ROM or other optical media. The hard disk drive 27, magnetic disk drive 28, and optical disk drive 30 are shown as connected to the system bus 23 by a hard disk drive interface 32, a magnetic disk drive interface 33, and an optical drive interface 34, respectively. The drives and their associated computer readable media provide non volatile storage of computer readable instructions, data structures, program modules and other data for the computer 20. Although the exemplary environment described herein employs a hard disk, a removable magnetic disk 29 and a removable optical disk 31, it should be appreciated by those skilled in the art that other types of computer readable media which can store data that is accessible by a computer, such as flash memory cards, digital video disks, random access memories (RAMs), read only memories (ROMs) and the like may also be used in the exemplary operating environment. Generally, such computer readable storage media can be used in some embodiments to store processor executable instructions embodying aspects of the present disclosure.

A number of program modules comprising computer-readable instructions may be stored on computer-readable media such as the hard disk, magnetic disk 29, optical disk 31, ROM 24 or RAM 25, including an operating system 35, one or more application programs 36, other program modules 37 and program data 38. Upon execution by the processing unit, the computer-readable instructions cause the actions described in more detail below to be carried out or cause the various program modules to be instantiated. A user may enter commands and information into the computer 20 through input devices such as a keyboard 40 and pointing device 42. Other input devices (not shown) may include a microphone, joystick, game pad, satellite dish, scanner or the like. These and other input devices are often connected to the processing unit 21 through a serial port interface 46 that is coupled to the system bus, but may be connected by other interfaces, such as a parallel port, game port or universal serial bus (USB). A monitor 47, display or other type of display device can also be connected to the system bus 23 via an interface, such as a video adapter 48. In addition to the display 47, computers typically include other peripheral output devices (not shown), such as speakers and printers. The exemplary system of FIG. 1 also includes a host adapter 55, Small Computer System Interface (SCSI) bus 56, and an external storage device 62 connected to the SCSI bus 56.

The computer 20 may operate in a networked environment using logical connections to one or more remote computers, such as a remote computer 49. The remote computer 49 may be another computer, a server, a router, a network PC, a peer device or other common network node, and typically can include many or all of the elements described above relative to the computer 20, although only a memory storage device 50 has been illustrated in FIG. 1. The logical connections depicted in FIG. 1 can include a local area network (LAN) 51 and a wide area network (WAN) 52. Such networking environments are commonplace in offices, enterprise wide computer networks, intranets and the Internet.

When used in a LAN networking environment, the computer 20 can be connected to the LAN 51 through a network interface or adapter 53. When used in a WAN networking environment, the computer 20 can typically include a modem 54 or other means for establishing communications over the wide area network 52, such as the Internet. The modem 54, which may be internal or external, can be connected to the system bus 23 via the serial port interface 46. In a networked environment, program modules depicted relative to the computer 20, or portions thereof, may be stored in the remote memory storage device. It will be appreciated that the network connections shown are exemplary and other means of establishing a communications link between the computers may be used. Moreover, while it is envisioned that numerous embodiments of the present disclosure are particularly well-suited for computerized systems, nothing in this document is intended to limit the disclosure to such embodiments.

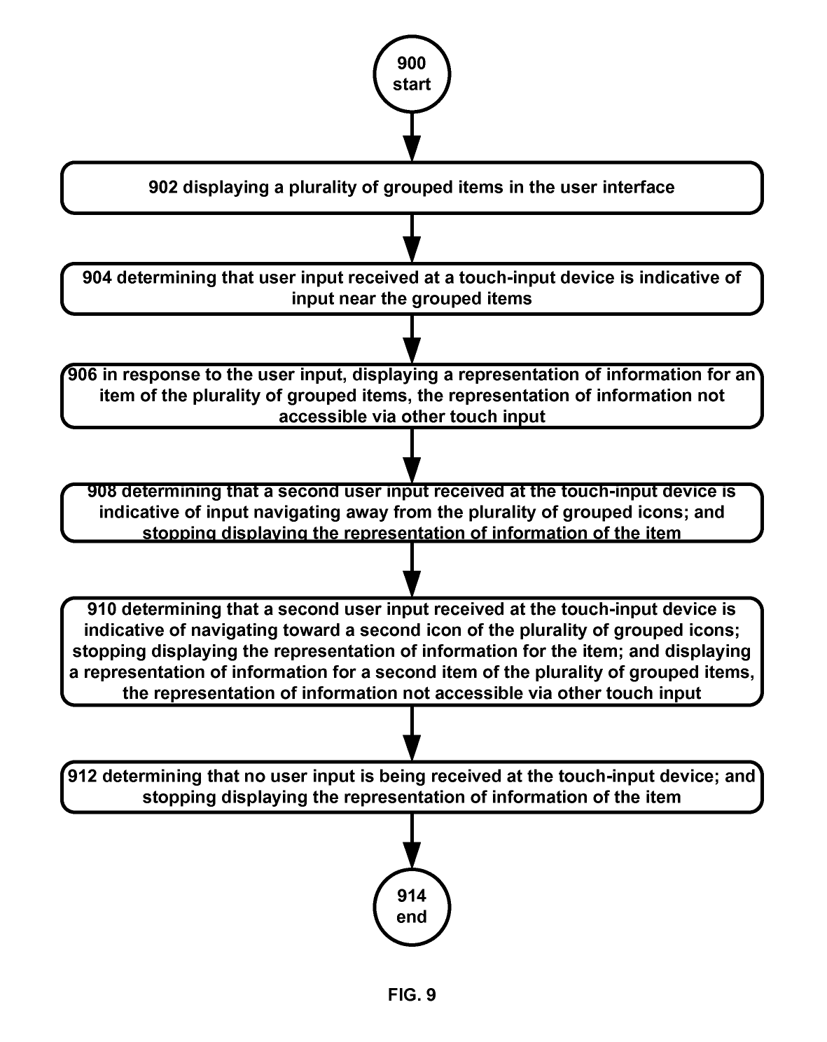

System memory 22 of computer 20 may comprise instructions that, upon execution by computer 20, cause the computer 20 to implement the invention, such as the operational procedures of FIG. 9.

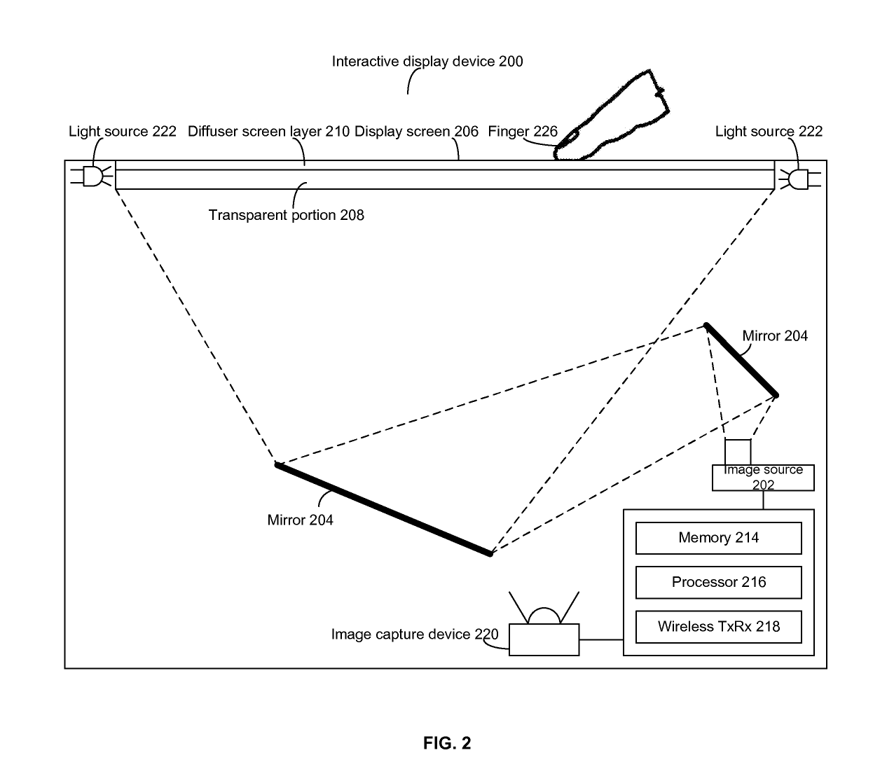

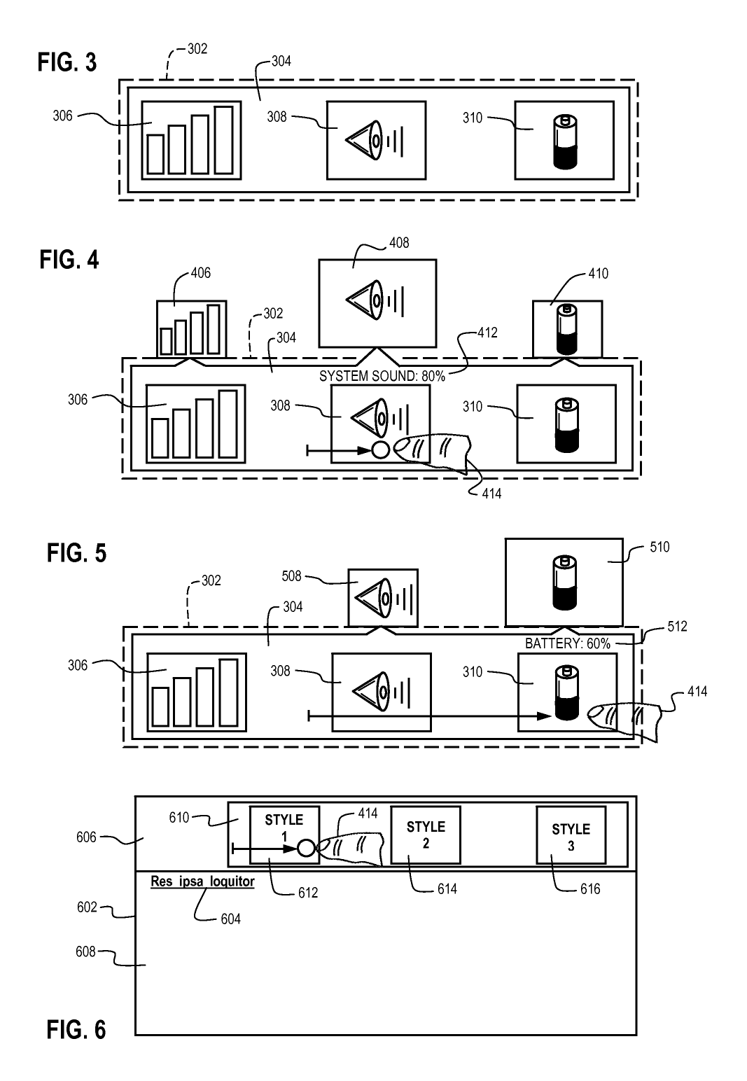

FIG. 2 depicts an example computer including a touch-sensitive surface in which an aspect of an embodiment of the invention can be implemented. The touch screen 200 of FIG. 2 may be implemented as the display 47 in the computing environment 100 of FIG. 1. Furthermore, memory 214 of computer 200 may comprise instructions that, upon execution by computer 200, cause the computer 200 to implement the invention, such as the operational procedures of FIG. 17, which are used to effectuate the aspects of the invention depicted in FIGS. 3-16.

The interactive display device 200 (sometimes referred to as a touch screen, or a touch-sensitive display) comprises a projection display system having an image source 202, optionally one or more mirrors 204 for increasing an optical path length and image size of the projection display, and a horizontal display screen 206 onto which images are projected. While shown in the context of a projection display system, it will be understood that an interactive display device may comprise any other suitable image display system, including but not limited to liquid crystal display (LCD) panel systems and other light valve systems. Furthermore, while shown in the context of a horizontal display system, it will be understood that the disclosed embodiments may be used in displays of any orientation.

The display screen 206 includes a clear, transparent portion 208, such as sheet of glass, and a diffuser screen layer 210 disposed on top of the clear, transparent portion 208. In some embodiments, an additional transparent layer (not shown) may be disposed over the diffuser screen layer 210 to provide a smooth look and feel to the display screen.

Continuing with FIG. 2, the interactive display device 200 further includes an electronic controller 212 comprising memory 214 and a processor 216. The controller 212 also may include a wireless transmitter and receiver 218 configured to communicate with other devices. The controller 212 may include computer-executable instructions or code, such as programs, stored in memory 214 or on other computer-readable storage media and executed by processor 216, that control the various visual responses to detected touches described in more detail below. Generally, programs include routines, objects, components, data structures, and the like that perform particular tasks or implement particular abstract data types. The term “program” as used herein may connote a single program or multiple programs acting in concert, and may be used to denote applications, services, or any other type or class of program.

To sense objects located on the display screen 206, the interactive display device 200 includes one or more image capture devices 220 configured to capture an image of the entire backside of the display screen 206, and to provide the image to the electronic controller 212 for the detection objects appearing in the image. The diffuser screen layer 210 helps to avoid the imaging of objects that are not in contact with or positioned within a few millimeters of the display screen 206, and therefore helps to ensure that only objects that are touching the display screen 206 (or, in some cases, in close proximity to the display screen 206) are detected by the image capture device 220. While the depicted embodiment includes a single image capture device 220, it will be understood that any suitable number of image capture devices may be used to image the backside of the display screen 206. Furthermore, it will be understood that the term “touch” as used herein may comprise both physical touches, and/or “near touches” of objects in close proximity to the display screen

The image capture device 220 may include any suitable image sensing mechanism. Examples of suitable image sensing mechanisms include but are not limited to CCD (charge-coupled device) and CMOS (complimentary metal-oxide-semiconductor) image sensors. Furthermore, the image sensing mechanisms may capture images of the display screen 206 at a sufficient frequency or frame rate to detect motion of an object across the display screen 206 at desired rates. In other embodiments, a scanning laser may be used in combination with a suitable photo detector to acquire images of the display screen 206.

The image capture device 220 may be configured to detect reflected or emitted energy of any suitable wavelength, including but not limited to infrared and visible wavelengths. To assist in detecting objects placed on the display screen 206, the image capture device 220 may further include an additional light source 222 such as one or more light emitting diodes (LEDs) configured to produce infrared or visible light. Light from the light source 222 may be reflected by objects placed on the display screen 222 and then detected by the image capture device 220. The use of infrared LEDs as opposed to visible LEDs may help to avoid washing out the appearance of projected images on the display screen 206.

FIG. 2 also depicts a finger 226 of a user's hand touching the display screen. While the embodiments herein are described in the context of a user's finger touching a touch-sensitive display, it will be understood that the concepts may extend to the detection of a touch of any other suitable physical object on the display screen 206, including but not limited to a stylus, cell phones, smart phones, cameras, PDAs, media players, other portable electronic items, bar codes and other optically readable tags, etc. Furthermore, while disclosed in the context of an optical touch sensing mechanism, it will be understood that the concepts disclosed herein may be used with any suitable touch-sensing mechanism. The term “touch-sensitive display” is used herein to describe not only the display screen 206, light source 222 and image capture device 220 of the depicted embodiment, but to any other suitable display screen and associated touch-sensing mechanisms and systems, including but not limited to capacitive and resistive touch-sensing mechanisms.

FIGS. 3-5 depict an aspect of an embodiment of the present invention, where the user interacts with a plurality of grouped icons over time. FIG. 3 depicts an example grouped plurality of items for which an aspect of an embodiment of the invention may be implemented. Area 304 comprises grouped items 306, 308, and 310. As depicted, item 306 comprises an icon for a computer's wireless network connection, item 308 comprises an icon for a computer's system sound, and item 310 comprises an icon for a computer's battery. These icons 306-310 are grouped and displayed within area 304. For example, in versions of the MICROSOFT WINDOWS operating system, area 304 may be the notification area of the WINDOWS taskbar, and icons 306-310 may be icons in the notification area that display system and program features.

Area 302 represents a boundary area for the grouped icons. This may serve as a boundary where the initial user touch input that occurs inside of this area (such as within area 302 as it is displayed on a touch screen where input is received) is recognized as being input that is interpreted as affecting area 304 and the icons 306-310 that it contains. This initial user touch input is the first time the user touches the touch screen after a period of having not touched the touch screen. There may also be embodiments that do not involve a boundary area such as boundary area 302. For instance, rather than making a determination as to what portion of a display is being manipulated as a result of the initial user touch input, the system may periodically re-evaluate the current user touch input and determine from that which area the input affects.

FIG. 4 depicts the grouped plurality of items of FIG. 3 for which a representation of information not otherwise available via user input is displayed in response to user touch input. As depicted in FIG. 4, a user has scrubbed within boundary 302 with his or her finger 414 and is now touching icon 308—the system sound icon. As a result of this, a representation of information not otherwise available through touch input is provided to the user. In this case, it is text 412 which indicates the volume level (“SYSTEM SOUND: 80%”) and magnified icon 408, which provides a larger representation of icon 308. Other representations of information not otherwise available via touch input may include a small pop-up window that identifies the purpose of the icon (such as that it is for system sound). In versions of the MICROSOFT WINDOWS operating system, such a pop-up window may be an “infotip.”

Also depicted in FIG. 4, are icons 406 and 410, which in combination with magnified icon 408 produce a “cascading” effect centered around the magnified icon 408 (for the icon that the user is currently manipulating). These icons 406 and 410 are displayed, though they are not as large as magnified icon 408, and corresponding text information is not also displayed, like text information 412 is displayed along with magnified icon 408. This may help the user identify that by scrubbing to nearby icons, he or she may obtain a representation of information about them not otherwise available via touch input, similar to how he or she is currently receiving such a representation of information for icon 308.

FIG. 5 depicts the grouped plurality of items of FIG. 4 for which a second representation of information not otherwise available via user input is displayed in response to additional user touch input. As depicted in FIG. 5, time has passed since the time depicted in FIG. 4, and now the user has scrubbed his or her finger 414 further to the right, so that it touches icon 310. As a result, in FIG. 5, the system displays a representation of information about icon 310 that is not otherwise available via touch input, whereas in FIG. 4, the system displayed a representation of information about icon 308 not otherwise available via touch input. The representation of information about icon 310 is text 512 (which reads “BATTERY: 60%,” and is similar to text 412 of FIG. 4), and magnified icon 510, which shows a magnified version of icon 310 (and is similar to magnified icon 408 of FIG. 4).

FIG. 5 also depicts a cascade effect similar to the cascade effect of FIG. 4. The cascade effect of FIG. 5 is centered on magnified icon 510, and involves icon 508. There is no additional small icon presented for icon 306, because in this cascade effect, only the nearest neighboring items to the left and right receive the effect. Similarly, there is no cascade effect displayed to the right of magnified icon 510, because item 310 is the rightmost item, so there is no item to the right of it for which a cascade effect may be created.

FIG. 6 depicts an example word processor window in which an aspect of an embodiment of the invention may be implemented, similar to how the invention may be implemented as depicted in FIGS. 3-5. FIG. 6 depicts a word processor window 602. Word processor window 602 comprises a text area 608 (which displays the text, “res ipsa loquitor” 604), where text is entered and displayed, and a menu area 606 where buttons to manipulate the word processor are displayed (such as a print, save, or highlight text button). Menu area 606 comprises a plurality of grouped items 610, which in turn is made up of item 612, item 614, and item 616. Each of items 612-616 is a “style” button—selecting one determines a style that will be used on text that is entered or displayed in text area 608. For instance, a style may set forth the font, size of the font, justification of the text, and whether the text is bolded, underlined, and/or italicized.

FIG. 6 depicts another version of the mouse-over/clicking distinction that is present in FIGS. 3-5. Whereas in FIGS. 3-5, clicking (or tapping, using a finger) an item may have caused an application window for that item to open, while scrubbing over the item shows information about that item (like magnified icon 510 and text 512), here in FIG. 6, clicking/tapping on an item may select that style until a new style is selected that overrides it, while scrubbing over the item shows a preview of how that style will affect the text 604 (and when the finger is no longer scrubbed on that item, the preview is no longer shown).

For instance, in FIG. 6, item 612 corresponds to style 612, which comprises bolding and underlining text. The user has scrubbed his or her finger 414 until it is over item 612, so a preview of that style is shown on text 604, and that text appears as both bolded and underlined. If the user later scrubs his or her finger 414 further to the right past item 612, that preview will no longer be shown, and a preview of style 2 or style 3 may be shown should the user scrub over item 614 or 616. It is in this difference between applying a style and obtaining a preview of a style that the invention provides a representation of information for an item of a plurality of grouped items via touch input, where the representation is not otherwise accessible via touch input.

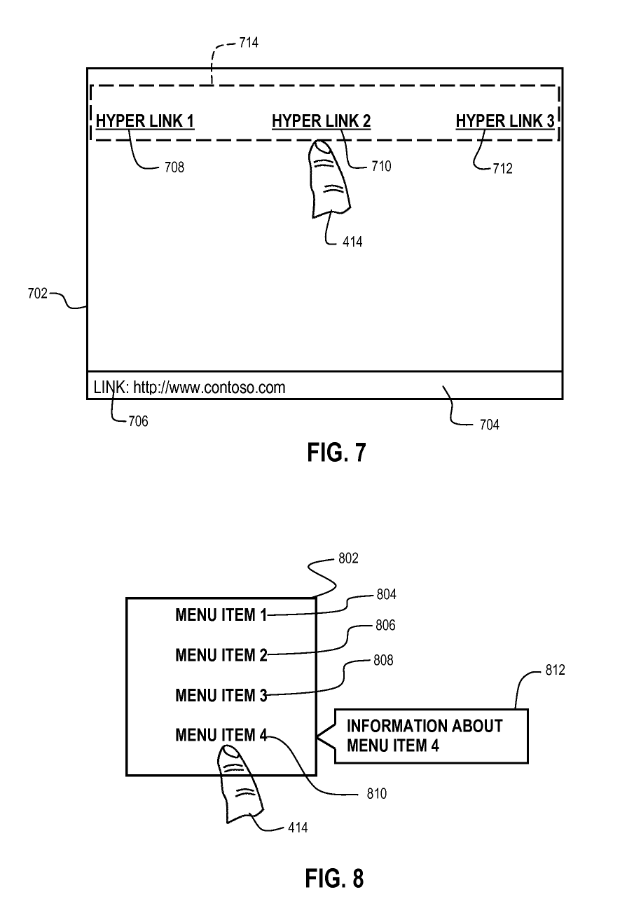

FIG. 7 depicts an example web browser window in which an aspect of an embodiment of the invention may be implemented. Among other ways, FIG. 7 differs from FIG. 6 in that, in FIG. 7, the items (items 708, 710, and 712) are text, whereas in FIG. 6, the items (items 612, 614, and 616) are icons. Web browser window 702 comprises status area 704. In the main body of web browser window 702 are a plurality of grouped items—hyper link 708, hyper link 710, and hyper link 712. The three grouped items 708-712 are contained within a boundary area 714, which may be similar to boundary area 302 of FIGS. 3-5, in that user input initially made within that area will be interpreted as applying to the plurality of grouped items 708-712.

As depicted in FIG. 7, a user has scrubbed his or her finger 414 within boundary area 714, and is now touching hyper link 2 710. As a result of this touch input, the system that displays web browser window 702 is displaying a representation of information not otherwise available via touch input in the form of the URL 706 for that hyperlink 710—“http://www.contoso.com.” That information itself might otherwise be available to the user in a different representation. For instance, if the user should click on that link, causing the web browser to load and display the web page located at http://www.contoso.com, and display “http://www.contoso.com” in its address bar. Though this information may be the same as is displayed in status area, it is a different representation of that information because it is located in an address bar rather than a status bar, and it is information about the current page being viewed, rather than the page that would be viewed should the user follow a link

FIG. 8 depicts an example text menu list in which an aspect of an embodiment of the invention may be implemented. FIG. 8 differs from FIGS. 3-6 in that the plurality of grouped items in FIG. 8 are all text items, whereas they are icons in FIGS. 3-6. FIG. 8 differs from FIG. 7 in that, while they both depict a plurality of grouped items that are text, in FIG. 7 that text was displayed within a page (items 708-712), whereas in FIG. 8 the text (items 804, 806, 808 and 810) is displayed in a menu list 802, such as a drop down menu. In FIG. 8, the user has engaged the menu list 802, and scrubbed his or her finger to menu item 4 810. As a result of this user input, the system that displays the menu list 802 is displaying a representation of information about menu item 4 812 that is not otherwise accessible via touch input. For instance, where menu item 4 810, when selected, causes a window associated with the menu list 802 to print, the representation of information about menu item 4 812 may be a pop-up window that indicates to which printer the window will be printed.

FIG. 9 depicts example operation procedures that implement an embodiment of the invention. The present invention may be effectuated by storing computer-readable instructions for performing the operations of FIG. 9 in memory 22 of computer 21 of FIG. 1. The operational procedures of FIG. 9 may be used to effectuate the aspects of embodiments of the invention depicted in FIGS. 2-8. The operational procedures of FIG. 9 begin with operation 900, which leads into operation 902.

Operation 902 depicts displaying a plurality of grouped items in the user interface. These grouped items may be the items 306-310 as depicted in FIGS. 3-5, items 612-616 as depicted in FIG. 6, items 708-712 as depicted in FIG. 7, or items 804-810 as depicted in FIG. 8. The items may be icons (as depicted in FIGS. 3-6), or text (as depicted in FIGS. 7-8). The items may be considered to be grouped insomuch as scrubbing a finger or otherwise providing touch input to an area of the items (such as boundary area 302 of FIG. 3) causes the present invention to provide a representation of information not otherwise accessible via touch input, based on which item of the plurality of grouped items is being engaged.

Operation 904 depicts determining that user input received at a touch-input device is indicative of input near the grouped items. This input near the grouped items may be, for instance, input within boundary area 302 of FIGS. 3-5, area 610 of FIG. 6, area 714 of FIG. 7, or area 802 of FIG. 8. The user input may comprise a finger press at the touch-input device, such as the interactive display 200 of FIG. 2, a stylus press at the touch-input device, or input otherwise effected using a touch-input device. The user input may comprise a scrub motion, where the user presses down on the touch-input device at an initial point and then, while maintaining contact with the touch-input device, moves his or her finger in a direction.

Operation 906 depicts, in response to the user input, displaying a representation of information for an item of the plurality of grouped items, the representation of information not accessible via other touch input. This representation of information not otherwise accessible via other touch input may be, for example, enlarged icon 408 and explanatory text 412 of FIG. 4, enlarged icon 510 and explanatory text 512 of FIG. 5, the preview of style 1 applied to text 604 of FIG. 6, an indication of the URL 706 of hyperlink 2 710 displayed in status area 704 of FIG. 7, or the information about menu item 4 812 of FIG. 8.

In an embodiment, operation 906 comprises enlarging the item in the user interface. This is shown in enlarged icons 408 and 510, of FIGS. 4 and 5, respectively. In an embodiment, operation 906 comprises displaying an animation of displaying the representation before displaying the representation. For instance, in FIG. 4, the representation of information not otherwise accessible via touch input includes magnified icon 408. In this embodiment, the magnified icon may be initially presented very small, and may be gradually enlarged to its full size as depicted in FIG. 4 via an animation.

In an embodiment, the representation comprises text or image information that informs the user of the purpose or status of the item. For instance, a user is informed of both item 308's purpose and status via explanatory text 412. The user is informed of the item's purpose via the text 412—the icon is for “SYSTEM SOUND.” The user is also informed of the item's status via the text 412—the status of system sound is that the sound level is 80%.

It may be that input is accepted into a system that implements the operational procedures of FIG. 9 includes both touch input and mouse input that includes an on-screen pointer. In such a scenario, it may be that this representation of information is accessible via mouse input, where the user performs a mouse-over with the on-screen pointer. It is in this manner that the representation of input is not accessible via other touch input, since it may be accessible via non-touch input.

Likewise, the information itself may be otherwise accessible via touch input, but the present representation of that information is not accessible via other touch input. Take, for example, FIG. 4, where the representation of information not otherwise accessible via other touch input includes explanatory text 412, which reads “SYSTEM SOUND: 80%.” It may be possible to otherwise determine that the system sound level is 80%. For instance, the user may tap his or her finger 414 on the system sound icon 308, which causes a separate window for the system sound settings to be presented, and that settings window may show that the current system sound level is 80%. In that sense, the information itself is otherwise accessible via other touch input, but it is represented in a different manner—via a separate window, as opposed to the present explanatory text 412 that is shown directly above icon 308, in the icon's 308 display area.

Furthermore, the representation may be otherwise accessible via touch input in that another touch gesture of the same type may cause it to be presented. For instance, where the gesture comprises scrubbing to the right until the touch corresponds to the item, a scrub that begins to the right of the item and moves to the left until the touch corresponds to the item may also cause the representation to be presented. However, other types of touch gestures or input may not cause the representation to be presented. For instance, tapping on the item, or performing a gesture on the item where the fingers converge or diverge (commonly known as “pinch” and “reverse-pinch” gestures“) may not cause this representation to be presented.

This concept of not being otherwise accessible via touch input can be seen in some address book applications. For instance, where scrubbing through a list of letters to the letter “M” may cause address book entries beginning with that letter to be displayed in a display area, a user may also scroll through the display area itself (such as through a “flick” gesture) to arrive at the point where entries beginning with “M” are displayed. In such a scenario, the representation of information is otherwise accessible via touch input.

Operation 908 depicts determining that a second user input received at the touch-input device is indicative of input navigating away from the plurality of grouped icons; and stopping displaying the representation of information of the item. The representation of information not otherwise accessible via other touch input need not be persistently displayed. Where the user scrubs toward the item so that the representation of information not otherwise accessible via other touch input is displayed, he or she may later scrub away from that item. In such a case, the representation is not persistently displayed, but is displayed only so long as the user is interacting with the item. So, where the user navigates away, the representation is no longer displayed.

Operation 910 depicts determining that a second user input received at the touch-input device is indicative of navigating toward a second icon of the plurality of grouped icons; stopping displaying the representation of information for the item; and displaying a representation of information for a second item of the plurality of grouped items, the representation of information not accessible via other touch input. Operation 910 can be seen in the difference between FIGS. 4 and 5. In FIG. 4, the user is interacting with a first item—item 308—and a representation of information for that item is being displayed (via enlarged icon 408 and explanatory text 412). FIG. 5 depicts a later point in time than in FIG. 4, and the user has now continued to scrub to the right until interacting with a second item of the plurality of grouped items—item 310. Now, in FIG. 5, a representation of information for that second item, item 310 is being displayed (via enlarged icon 510 and explanatory text 512).

Operation 912 depicts determining that no user input is being received at the touch-input device; and stopping displaying the representation of information of the item. Similar to operation 908, where displaying the representation of information terminates where the user's input now indicates that it is not interacting with the item, the displaying of the representation of information may terminate or stop where the user lifts his or her finger or other input means (such as a stylus) from the touch-input area. In response to this, at operation 912, displaying the representation is terminated.

The operational procedures of FIG. 9 end with operation 914. It may be appreciated that embodiments of the invention may be implemented with a subset of the operational procedures of FIG. 9, or with a permutation of these operational procedures. For instance, an embodiment of the invention may function where it implements operational procedures 900, 902, 904, 906, and 914. Likewise, an embodiment of the invention may function where operation 910 is performed before operation 908.

### CONCLUSION

While the present invention has been described in connection with the preferred aspects, as illustrated in the various figures, it is understood that other similar aspects may be used or modifications and additions may be made to the described aspects for performing the same function of the present invention without deviating there from. Therefore, the present invention should not be limited to any single aspect, but rather construed in breadth and scope in accordance with the appended claims. For example, the various procedures described herein may be implemented with hardware or software, or a combination of both. Thus, the methods and apparatus of the disclosed embodiments, or certain aspects or portions thereof, may take the form of program code (i.e., instructions) embodied in tangible media, such as floppy diskettes, CD-ROMs, hard drives, or any other machine-readable storage medium. When the program code is loaded into and executed by a machine, such as a computer, the machine becomes an apparatus configured for practicing the disclosed embodiments. In addition to the specific implementations explicitly set forth herein, other aspects and implementations will be apparent to those skilled in the art from consideration of the specification disclosed herein. It is intended that the specification and illustrated implementations be considered as examples only.

What is claimed:

1. A method for providing a user interface in a touch-input environment, comprising:
displaying a plurality of grouped items in the user interface;
determining that user input received at a touch-input device is indicative of input near the grouped items; and
in response to the user input, displaying a representation of information for an item of the plurality of grouped items, the representation of information not accessible via other touch input.

2. The method of claim 1, further comprising:
determining that a second user input received at the touch-input device is indicative of navigating toward a second icon of the plurality of grouped icons;
stopping displaying the representation of information for the item; and
displaying a representation of information for a second item of the plurality of grouped items, the representation of information not accessible via other touch input.

3. The method of claim 1, wherein displaying a representation of information for an item comprises:
enlarging the item in the user interface.

4. The method of claim 1, further comprising:
determining that a second user input received at the touch-input device is indicative of input navigating away from the plurality of grouped icons; and
stopping displaying the representation of information of the item.

5. The method of claim 1, wherein displaying a representation of information for an item comprises:
displaying an animation of displaying the representation before displaying the representation.

6. The method of claim 1, further comprising:
determining that no user input is being received at the touch-input device; and
stopping displaying the representation of information of the item.

7. The method of claim 1, wherein the representation comprises:
text or image information that informs the user of the purpose or status of the item.

8. The method of claim 1, wherein the user input comprises:
a scrub.

9. The method of claim 1, wherein the user input comprises a finger press at the touch-input device.

10. The method of claim 1, wherein the user input comprises a stylus press at the touch-input device.

11. A system for providing a user interface in a touch-input environment, comprising:
a processor; and
a memory communicatively coupled to the processor when the system is operational, the memory bearing processor-executable instructions that, upon execution by the processor, cause the processor to perform operations comprising:
displaying a plurality of grouped items in the user interface;
determining that user input received at a touch-input device is indicative of input near the grouped items; and
in response to the user input, displaying a representation of information for an item of the plurality of grouped items, the representation of information not accessible via other touch input.

12. The system of claim 11, wherein the memory further bears processor-executable instructions that, upon execution by the processor, cause the processor to perform operations comprising:
determining that a second user input received at the touch-input device is indicative of navigating toward a second icon of the plurality of grouped icons;
stopping displaying the representation of information for the item; and
displaying a representation of information for a second item of the plurality of grouped items, the representation of information not accessible via other touch input.

13. The system of claim 11, wherein the memory further bears processor-executable instructions that, upon execution by the processor, cause the processor to perform operations comprising:
enlarging the item in the user interface.

14. The system of claim 11, wherein the memory further bears processor-executable instructions that, upon execution by the processor, cause the processor to perform operations comprising:
determining that a second user input received at the touch-input device is indicative of input navigating away from the plurality of grouped icons; and
stopping displaying the representation of information of the item.

15. The system of claim 11, wherein the memory further bears processor-executable instructions that, upon execution by the processor, cause the processor to perform operations comprising:
displaying an animation of displaying the representation before displaying the representation.

16. The system of claim 11, wherein the memory further bears processor-executable instructions that, upon execution by the processor, cause the processor to perform operations comprising:
determining that no user input is being received at the touch-input device; and
stopping displaying the representation of information of the item.

17. The system of claim 11, wherein the representation comprises:
text or image information that informs the user of the purpose or status of the item.

18. The system of claim 11, wherein the user input comprises:
a scrub.

19. The system of claim 11, wherein the user input comprises a finger press at the touch-input device.

20. A computer-readable storage bearing computer-executable instructions that, upon execution by a computer, cause the computer to perform operations comprising:
displaying a plurality of grouped items in the user interface;
determining that user input received at a touch-input device is indicative of input near the grouped items; and
in response to the user input, displaying a representation of information for an item of the plurality of grouped items, the representation of information not accessible via other touch input.
